(19) United States
(12) Patent Application Publication
(10) Pub. No.: US 2007/0220083 A1
(43) Pub. Date: Sep. 20, 2007

(54) Estimation of initial dynamic rendering control data

(75) Inventors: Nikhil Kothari, Sammamish, WA (US); Polita Mila Paulus, Kirkland, WA (US); Bertrand C. Le Roy, Bellevue, WA (US); Eilon J. Lipton, Bellevue, WA (US); Kashif Alam, Kirkland, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/377,995

(22) Filed: Mar. 17, 2006

(51) Int. Cl. G06F 15/16; G06F 17/30; G06F 15/173

(52) U.S. Cl. 709/203; 709/217; 707/1; 709/238

(57) ABSTRACT

Facilitation of web page rendering using dynamic rendering controls. A server identifies a representation of a page to be downloaded to a client. The representation includes a dynamic rendering control that may be used to render a portion of the page. Rather than leaving it to the client to gain access to the initial set of data that is to be used by the dynamic rendering control to properly render, the server estimates the initial set of data that is to be used, and transmits a network response that includes the estimated initial set of data. When executing the rendering component, the client may simply use the data provided in the network response to render the portion of the page, rather than having to gain access to the data from a network source.

### BACKGROUND

Computing technology has contributed enormously to the advancement of humankind. Computing systems come in a wide variety of physical forms including desktop computers, laptop computers, personal digital assistants, telephones, and even devices that have not been conventionally thought of as computing systems such as, for example, refrigerators and automobiles. Thus, a computing system may be any device or system that has a processor and a memory of any type.

Often computing systems are networked together such that the computing systems may communicate. A network may be as simple as a single wired or wireless link coupling two computers or as complex as the Internet. Many of the most commonly used applications rely on network technologies. Such applications include, for example, e-mail, instant messaging, web browsing, remote network access, electronic whiteboarding, voice-over-IP telephone communication, video conferencing, remote synchronization, and many others. In Web browsing technology, one computing system (often referred to loosely as a “client”) sends a request for a page to another computing system (referred to loosely as a “server”). The server then responds with a representation of the page to the client, where it is displayed on the screen.

There are several broad techniques for downloading a page such that it can be displayed at the client. One technique involves the server generating complete rendering instructions for the page, and then downloading the rendering instructions to the client. The client then parses and executes the rendering instructions. An example of rendering instructions would be a HyperText Markup Language (HTML) page. An advantage of this technique is that the entire page may be downloaded in a single request-response round trip. A disadvantage of this technique is that if the page is to be changed in any way (e.g., when the user selects a portion of the page), upon the client sending a new request to the server, the server sends another complete set of rendering instructions to the client. This requires significant processing resources on the server to formulate rendering instructions each time the page is to be altered in any way.

Another technique is quite different and does not require that the entire page be downloaded each time the page is to change. When a server receives a request for a page, the server only generates part of the rendering instructions that will be needed to render the page. For example, the server might generate HTML representing scaffolding for the page. The server downloads the HTML along with controls that are executed at the client. The controls include logic that permits the client to perform one or more functions. In order to perform their function(s), the control may potentially interact with other client-side controls, or even with a server. One type of control (also referred to herein as a “dynamic rendering control”) renders out rendering instructions such as, for example, HTML. The dynamic rendering controls permit the logic to consider state information that is known to the client, but not necessarily the server, when rendering a control. If the state information changes, the displayed form of the control may also change without re-requesting a page from a server. Thus, in many cases, the use of dynamic rendering controls embedded within HTML scaffolding permits greater flexibility.

Unfortunately, sometimes the client does not always have all the information needed by the dynamic rendering control in order to properly render on the display. In that case, the dynamic rendering control causes the client to request the information over a network, either from the server that originally downloaded the page to the client, or from a different server or server cluster altogether. Thus, although the use of dynamic rendering control technology can be more flexible, it also may require a second request-response round-trip thereby introducing further latency and network bandwidth requirement when rendering a page.

### BRIEF SUMMARY

Although not required, embodiments of the present invention relate to the downloading of a page to a client. When a server receives a request for the page from the client, the server identifies a representation of the page that corresponds to the network request, the representation including a dynamic rendering control that may be used to render a portion of the page. Rather than leaving it to the client to gain access over a network to initial data that is to be used by the dynamic rendering control to properly render its portion of the initial page, the server estimates at least some of this initial data. The server then transmits a network response that includes all or some of the initial data. When executing the dynamic rendering control, the client may simply use the initial data provided in the network response to render the portion of the page, rather than having to gain access to the initial data from a network source in a second round-trip.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The appended drawings are used in order to more particularly describe embodiments of the present invention. Understanding that these drawings depict only typical embodiments of the invention and are not therefore to be considered to be limiting of its scope, the embodiments will be described and explained with additional specificity and detail through the use of the accompanying drawings in which:

FIG. 1 illustrates a computing system in which embodiments of the principles of the present invention may operate;

FIG. 2 illustrates a request-response flow between a client and server in which the response includes initial data for a dynamic rendering component in accordance with embodiments of the present invention;

FIG. 3A illustrates a flowchart of a method for initially rendering a page using initial data provided by the server in accordance with embodiments of the present invention;

FIG. 3B illustrates a flowchart of a method for a dynamic rendering control to re-rendering its associated portion of the page;

FIG. 4 schematically illustrates a representation of a page with an associated initial data source data structure; and

FIG. 5 illustrates a flowchart of method for the server to access the initial data from another network source using the initial data source data structure.

### DETAILED DESCRIPTION

Embodiment of the present invention extend to the facilitation of web page rendering by a server by providing initial data for a dynamic rendering control when downloading the initial web page containing the dynamic rendering control to the client. Thus, rather than the client further requesting initial data for the dynamic rendering control to render its portion of the initial page, the dynamic rendering control may simply use the initial data provided in the response to the original page request to render its portion of the web page. Thus, the page may be initially rendered using a single request-response round trip while still permitting the use of dynamic rendering controls to update the web page as updates are warranted.

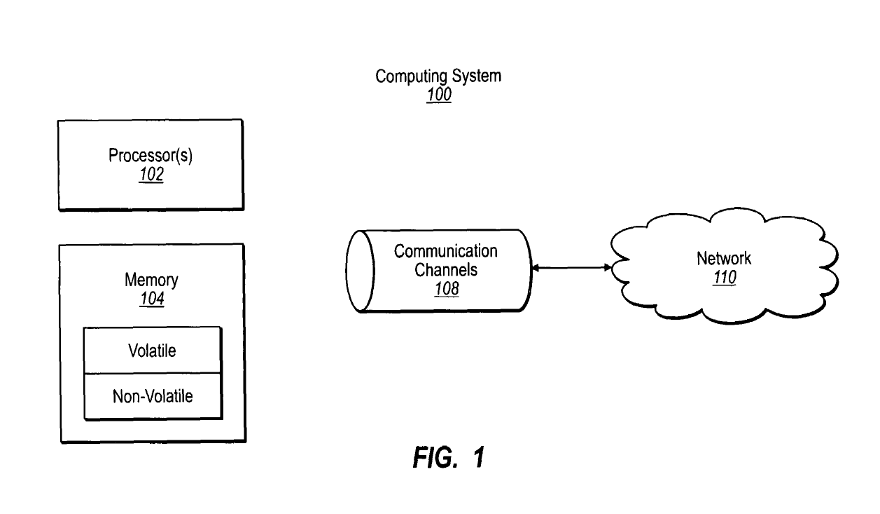

The embodiments of the present invention may comprise a special purpose or general-purpose computer including various computer hardware, as discussed in greater detail below. FIG. 1 shows a schematic diagram of an example computing system 100 that may be used to implement features of the present invention. The described computing system is only one example of such a suitable computing system and is not intended to suggest any limitation as to the scope of use or functionality of the invention. Neither should the invention be interpreted as having any dependency or requirement relating to any one or combination of components illustrated in FIG. 1.

Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

Referring to FIG. 1, in its most basic configuration, a computing system 100 typically includes at least one processing unit 102 and memory 104. The memory 104 may be system memory, which may be volatile, non-volatile, or some combination of the two. An example of volatile memory includes Random Access Memory (RAM). Examples of non-volatile memory include Read Only Memory (ROM), flash memory, or the like. The term “memory” may also be used herein to refer to non-volatile mass storage such as physical storage media. Such storage may be removable or non-removable, and may include (but is not limited to) PCMCIA cards, magnetic and optical disks, magnetic tape, and the like.

As used herein, the term “module” or “component” can refer to software objects or routines that execute on the computing system. The different components, modules, engines, and services described herein may be implemented as objects or processes that execute on the computing system (e.g., as separate threads). While the system and methods described herein may be implemented in software, implementations in hardware, and in combinations of software and hardware are also possible and contemplated.

In the description that follows, embodiments of the invention are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other computing systems over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

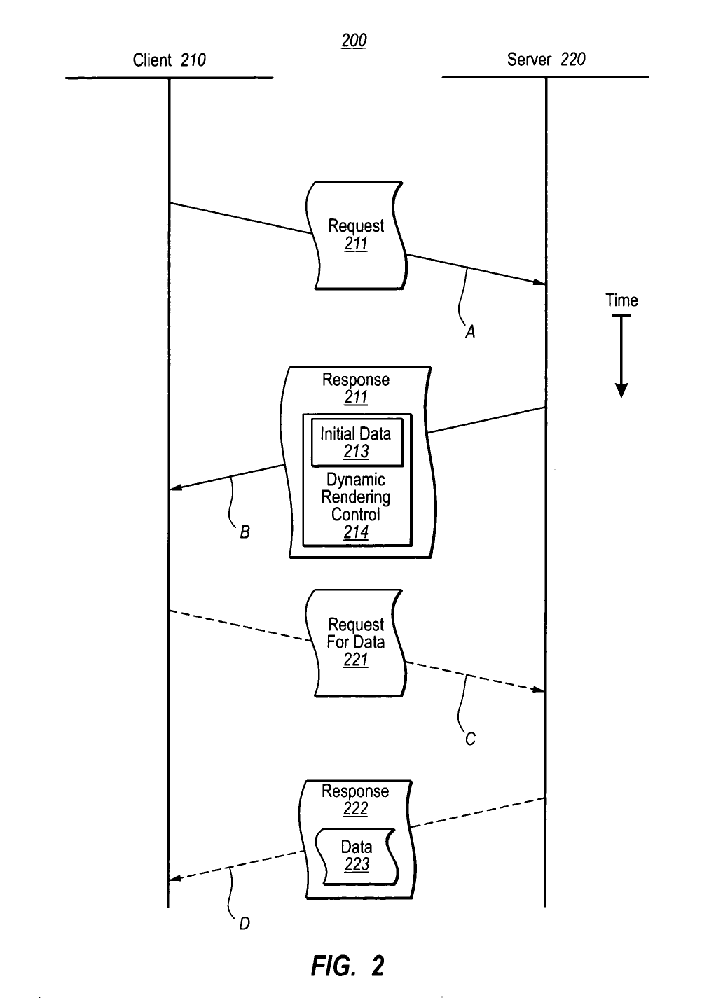

FIG. 2 illustrates a logic flow of communications between a client 210 and a server 220 in order to facilitate the downloading of a page in accordance with the principles of the present invention. The page may be, for example, a web page, which may include text-based markup language that represent static rendering instructions that the client may parse and execute in order to display a static portion of the page. For instance, web pages are often formulated using HyperText Markup Language (HTML) as its basic scaffolding, with script components or other markup language components (such as eXtensible Markup Language (XML) components).

The page may also include one or more dynamic rendering controls. When instantiated, the dynamic rendering control dynamically renders a portion of the page using relevant data. Such relevant data may be present within the dynamic rendering control provided from the server, may be present on the client, or may be obtained by the client over a network. If the relevant data should change, the dynamic rendering control may re-render the portion of the page without the client having to re-request an updated web page. Thus, the dynamic rendering controls are dynamic and flexibly respond to changing data.

In this description and in the claims, there may be occasional reference to a “client” computing system” and a “server” computing system. In this description and in the claims, the terms “client” and “server” are intended to be interpreted broadly. The term “server” or “server computing system” is thus any computing system that offers a service of any kind to another computing system. The term “client” or “client computing system” is any computing system that consumes any kind of service offered by another computing system. Those of ordinary skill in the art will recognize that networking technologies have become much more complex than simple client-server topologies of the past. Thus, a single computing system may both consume and provide services, and thus may be both a client and server computing system.

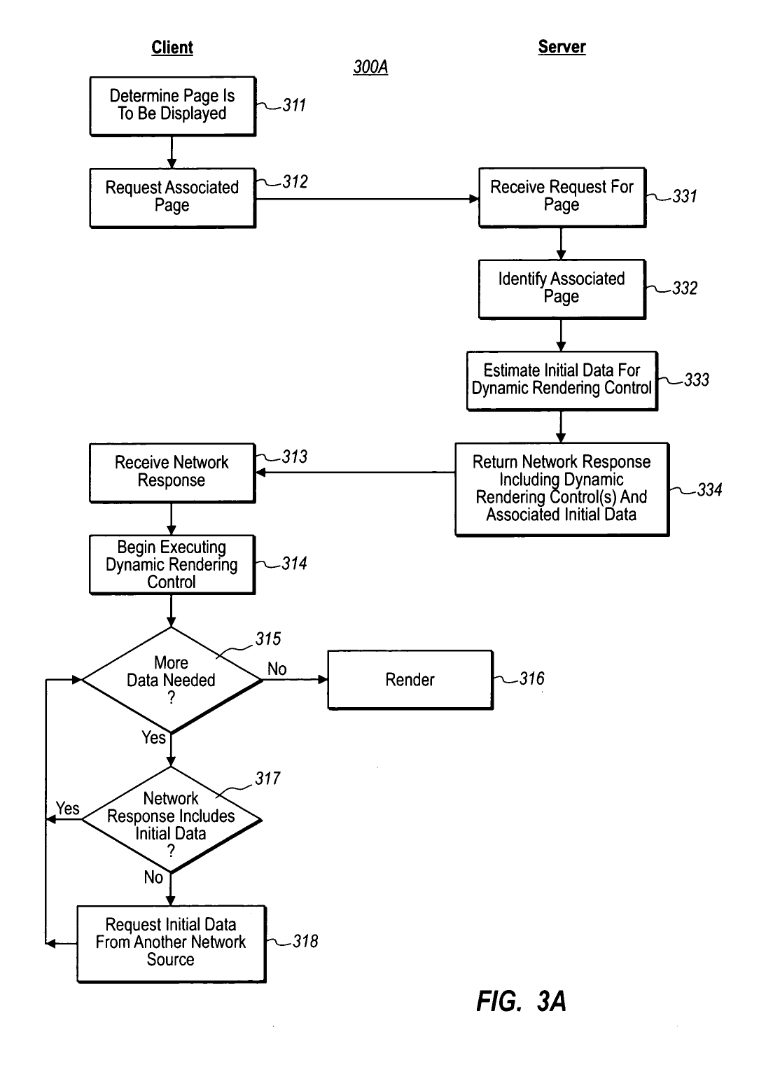

FIG. 3A illustrates a flowchart of a method 300A for downloading a web page in a manner that dynamic rendering controls are facilitated without requiring that the dynamic rendering controls make their own request for additional data required to render. Thus, the initial web page may be displayed using a single round trip request-response combination, thereby improving efficiency and performance in the display of the initial page. Acts performed by the client 210 of FIG. 2 are listed in the left half of FIG. 3A under the heading “Client”. Acts performed by the server 220 of FIG. 2 are listed in the right half of FIG. 3A under the heading “Server”. The method 300 may be performed using the logical flow 200 of FIG. 2. Accordingly, FIG. 2 and FIG. 3A will now be described with frequent reference to each other.

The client determines that a page is to be displayed (act 311). For instance, a user may interface with a web browser, and select a hyperlink within a current web page, or perhaps select a Uniform Resource Locator (URL). For instance, a URL may be selected by typing in a URL in the address field of the web browser.

In response, the client then submits a request for the associated page (act 312). This request (also called herein a “network request”) is represented in FIG. 2 as request 211, whereas its transmission is represented using arrow A. The request may conform to any version of the HyperText Transport Protocol (HTTP) and may be, for example, an HTTP GET request. However, the request may be any request in accordance with any protocol that permits the request to be communicated between the client and server.

Upon receiving the network request for the page from the client (act 331), the server identifies a representation of the page that corresponds to the network request (act 332). For instance, the server may access and/or formulate rendering instructions for the client to execute when rendering the page.

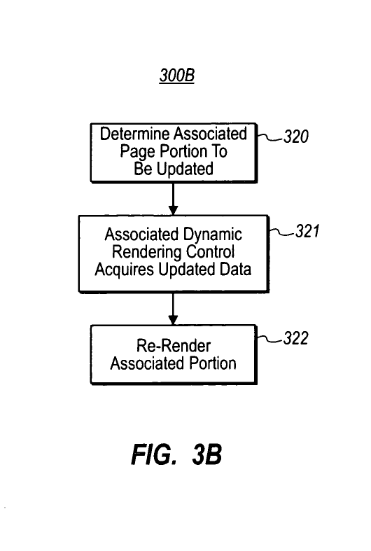

FIG. 4 abstractly illustrates a page representation data structure 400 that may be present on, accessed by, or formulated by the server. The page representation includes static rendering instructions 401, which may be, for example, HTML code that defines the basic scaffolding of the page. The page representation 400 may also optionally include script 402, which may be executed by the client to render dynamic portions of the page. The page representation 400 may also include at least one dynamic rendering control 403, instances of which will allow the client to dynamically render a corresponding portion of the page using relevant data present in the dynamic rendering control, on the client and/or over a network. The page representation 400 may include other items as well as represented by the vertical elipses 404.

Rather than leave it to the client to access over a network any initial data needed for the dynamic rendering control to properly render, the server estimates initial data that the dynamic rendering control needs to initially render the portion of the page (act 333). This estimation may be accomplished in whatever manner provides the initial data needed to render the associated portion of the initial page. In one embodiment, the author of the page simply includes a data structure (e.g., hereinafter referred to as an “initial data source data structure” for clarity) that is associated with the page at the server. For instance, the initial data source data structure 410 is illustrated with an association 411 with the page representation 400 of the desired page. The initial data source data structure 410 may even be initially included within the page representation 400.

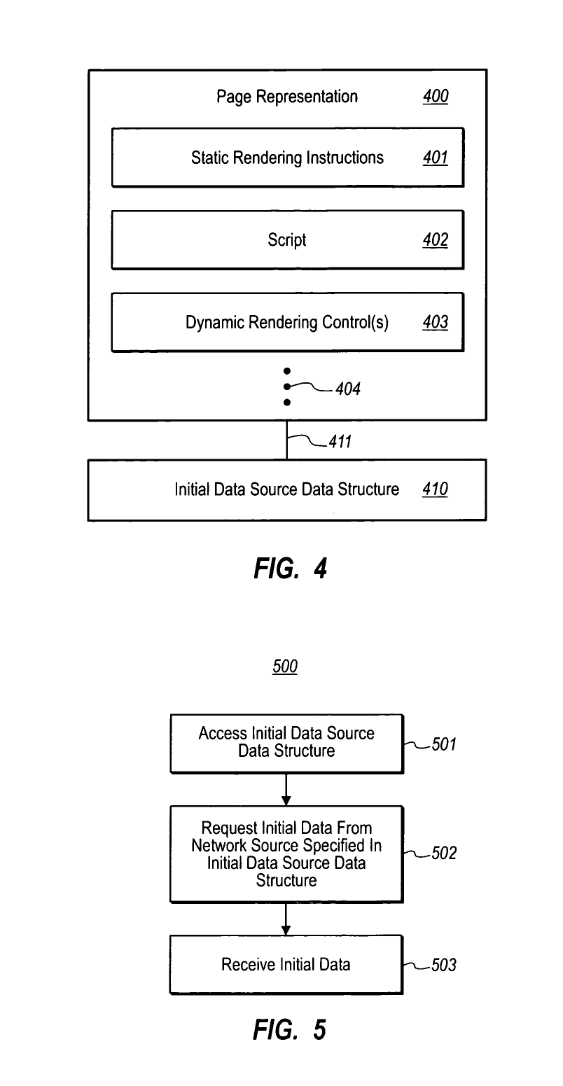

The initial data may be included within the initial data source data structure. In that case, estimating the initial data would simply involve accessing of the initial data source data structure 410, and ensuring that the initial data included within the initial data source data structure is included within the response. Alternatively, if the initial data for the dynamic rendering component is not within the initial data source data structure 410, the initial data source data structure 410 might include instructions to the server on how to access the initial data. For this latter scenario, FIG. 5 illustrates a method 500 for estimating the initial data when the server is required to access the initial data over a network.

Specifically, the server accesses the initial data source data structure associated with the page representation (act 501). In this case, the initial data source data structure provides a network source from which the initial data may be obtained. The server then requests the initial data from the network source specified in the initial data source data structure (act 502), whereupon the initial data is received from the network source (act 503).

For instance, the initial data source data structure may appear as follows as represented in XML pseudo code at the server:

```
<asp:InitialData RunAt=”Server”
    SourceURL=“MYSVC.ASMX”
    AssociatedDataSource=“DS1” />
```

In this data structure, the data structure is titled “InitialData”, and the attribute “RunAt” has a value “Server” indicating that the data structure is to be resolved at this server, rather than being sent to the client for execution. The SourdceURL element specifies that the initial data may be found at the location corresponding to the URL “MYSVC.ASMX”. The AssociatedDataSource element specifies that the initial data corresponds to a data source element that is included within the page. Thus, when the initial data is accessed, the initial data may be placed within or associated with that data source element. The client may then know where to find the initial data.

Returning back to FIG. 3, the initial data may thus be estimated (act 323). In this description and in the claims, “estimation” of initial data may also include the deterministic identification of the initial data. Accordingly, the use of the term “estimate” should not be construed as requiring that there is any uncertainty as to whether or not the initial data is correct. However, the principles of the present invention on do extend to situations in which the correctness of the initial data may be in doubt.

Regardless of how the initial data is estimated, the server then transmits a network request corresponding to the request to the client (act 334). In FIG. 2, the network response is represented by response 212, whereas its transmission is represented by arrow B. The network response 212 includes at least a transformed version of the representation of the page and the estimated initial data for its dynamic rendering component. This initial data is schematically represented by the initial data 213 being included within or associated with a dynamic rendering control 214 within the network response 212 of FIG. 2. The page representation may be, for example, a text-based representation (such as an HTML web page) that is transformed into a format suitable for transmission. For instance, the web page may be compressed and/or encrypted, and serialized. Initial data may be estimated and included in the network response for more than one of the dynamic rendering controls included in the network response.

Once the client receives the network response (act 313), the client then displays the web page. In order to do this, the client executes any of the static rendering instructions (see 401 of FIG. 4) and script (see 402 of FIG. 4) included within the page representation provided by the server. In addition, the client begins executing each dynamic rendering control (act 314).

In order to execute the dynamic rendering control, the client first instantiates the dynamic rendering control using relevant information present at the client. The dynamic rendering control may be a node in a rendering control tree. For instance, the rendering control might be a “ListView” control, although the principles of the present invention are not limited to the type of the control.

The dynamic rendering control then determines whether additional initial data is needed in order to fully render its portion of the web page (decision block 315). If not (No in decision block 315), the corresponding portion of the web page may be rendered using the dynamic rendering control (act 316). If so (Yes in decision block 315), the dynamic rendering control then determines whether the network response includes an estimate of the initial data (decision block 317). If the initial data is present in the network response (Yes in decision block 317), then the dynamic rendering control then determines whether it now has all of the initial data needed to render its portion of the initial page (back to decision block 315) in light of the additional initial data found in the network response.

In one embodiment, the initial data may have been acquired from a data source data structure within the page representation. In that case, the initial data may be accessed by the dynamic rendering control querying the data source component for the initial data, whereupon the data source component provides the initial data to the rendering component.

For instance, suppose the dynamic rendering control was a “ListView” control. The dynamic rendering control may appear as follows:

<ListView AssociatedDataSource=“D1”
OTHER LIST VIEW ATTRIBUTES AND STATE
/>

This ListView control specifies that the data source to which it is to go to access the initial data is identified by “D1”. The following represents an example of a corresponding data source control identified as “D1”:

```
<DataSource ID = “D1”>
    <Data>
        INITIAL DATA
    </Data>
</DataSource>
```

Here the initial data is included within the Data element of the Data Source control. The data source control includes an attribute “ID” that identifies the data source component as “D1”. Thus, the ListView component would access the initial data within the data source control. This initial data may be structured data (such as might be represented using XML) or may be unstructured data, so long as the data may be interpreted by the dynamic rendering control or altered by the client to be interpretable by the dynamic rendering control.

In this case (Yes in decision block 317 followed by No in decision block 315), the initial data was included in the network response, and thus the dynamic rendering control was able to render without having to perform a second request-response round trip. If there is initial data for one or more of the dynamic rendering controls that would normally require one or more additional request-response round trips, the rendering process has been saved from those additional round trips, thereby improving performance in rendering the initial web page. The savings is especially apparent when one considers that there may be a number of dynamic rendering controls in a web page. and that each of those dynamic rendering controls may require more than one additional round trip in order to gain all of the data required to render its respective portion of the display.

For instance, if the network response had not included the initial data (No in decision block 317), the client would then request the data from another network source (act 318). For instance, in FIG. 2, the client sends a request 221 for data as represented by transmission C. That other network source may be the server 220 or may be some other server. This request may involve the dynamic rendering control querying the data source control for the data. In response, the data source control may request the additional data from a network source that is identified in the data source control. For instance, the data source control may have instead be structured as follows:
<DataSource ServiceURL=“MYSVC.ASMX” ID=“D1”>

Once the data is returned to the data source control over the network (see transmission D including the second response 222 that contains the data 223 in FIG. 2), the data source control would then return the data to the dynamic rendering control. The dynamic rendering control may then use the data acquired from the other network source to render the portion of the web page using the rendering component (act 316).

This permits the initial web page to be rendered with a single request and response in the case where the initial data is returned in the response to the initial web page request. FIG. 3B illustrates a process 300B that would occur at the client if the web page were to be updated once a dynamic rendering control determines that its associated portion of the web page is to be updated. Specifically, upon detecting that its portion of the web page is to be updated (act 320), the dynamic rendering control accesses updated data needed to render the updated page (act 321). This may involve the dynamic rendering control accessing the updated data over a network. The dynamic rendering control then uses the updated data to update its portion of the web page (act 322).

Although methods have been described with respect to FIGS. 3A and 3B, the principles of the present invention extend to computer program product comprising one or more computer-readable media having thereon one or more computer-executable instructions that, when executed by one or more processors of the server computing system, cause the computing system to perform all or portions or either or both of these methods. For instance, referring to FIG. 1, memory 104 and communication channels 108 may represent examples of such computer-readable media. The memory 104 represents an example of physical computer-readable media in the form of physical storage and/or memory media. The principles of the present invention also extend to computing systems themselves that are configured through hardware, software, or a combination of hardware and software, to perform all of portions of the methods of FIG. 3A and/or FIG. 3B.

Accordingly, the principles of the present invention allow a mechanism to use dynamic rendering controls in pages while avoiding any need for the dynamic rendering controls to use additional network bandwidth to acquire information needed for the dynamic rendering control to initially render. This thereby improves efficiency in rendering web pages.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a server computing system to facilitate rendering of a page at a client, the method comprising:
an act of receiving a network request for a page from a client;
an act of identifying a representation of the page that corresponds to the network request, wherein the representation includes at least one dynamic rendering control that may be used to render a portion of the page;
an act of estimating some or all of an initial set of data that the dynamic rendering control needs to properly render the portion of the page; and
an act of transmitting a network response to the client, the network response corresponding to the network request and including at least a transformed version of the representation of the page and some or all of the initial set of data.

2. A method in accordance with claim 1, wherein the representation of the page is a text-based representation and is transmitted using a transformed version of the representation of the page.

3. A method in accordance with claim 2, wherein the transformed version of the representation of the page is a version of the text-based representation that is transformed into a format suitable for transmission.

4. A method in accordance with claim 1, wherein the act of estimating some or all of the initial set of data comprises:
an act of accessing an initial data source data structure from the representation of the page, the initial data source data structure specifying the initial set of data.

5. A method in accordance with claim 1, wherein the act of estimating some or all of the initial set of data comprises:
an act of accessing an initial data source data structure from the representation of the page, the initial data source data structure providing a network source from which the initial data may be obtained;
an act of requesting the initial data from the network source; and
an act of receiving the initial data from the network source in response to requesting the initial data from the network source.

6 A computer program product comprising one or more computer-readable media having thereon one or more computer-executable instructions that, when executed by one or more processors of the server computing system, cause the computing system to perform the method of claim 1.

7. A computing system configured to perform the method recited in claim 1.

8. A method for a client computing system to download a page, the method comprising:
in response to a request for a web page being sent to a server, an act of receiving a response to the request in the form of a representation of the web page that includes at least one dynamic rendering control that may be used to render a portion of the web page;
an act of executing the dynamic rendering control;
while executing the dynamic rendering control, performing the following:
an act of determining that additional data is needed in order to fully render the portion of the web page;
an act of determining whether or not the network response also includes an estimate of the additional data; and
if it is determined that the network response includes the estimate of the additional data, an act of using the estimate of the additional data to render the portion of the web page using the dynamic rendering control; and
if it is determined that the network response does not include the estimate of the additional data, an act of requesting the additional data from another network source; and an act of using the additional data acquired from the other network source to render the portion of the web page using the dynamic rendering control.

9. A method in accordance with claim 8, wherein the network response includes a representation of a data source control, wherein the act of using the estimate of the additional data comprises:
an act of the dynamic rendering control querying the data source control for the additional data; and
an act of the data source control providing the additional data included in the data source control to the dynamic rendering component.

10. A method in accordance with claim 8, wherein the network response includes a representation of a data source control, wherein the act of requesting the additional data from another network source comprises:
an act of the dynamic rendering control querying the data source control for the additional data; and
an act of the data source control requesting the additional data from a network source that is identified in the data source component.

11. A method in accordance with claim 8, further comprising:
an act of detecting that the web page is to be updated;
an act of the dynamic rendering control accessing updated data; and
an act of the dynamic rendering control re-rendering the portion of the web page using the updated data.

12. A method in accordance with claim 11, wherein the act of the dynamic rendering control accessing updated data comprises:
act of the client computing system requesting the updated data over a network.

13. A method in accordance with claim 8, wherein the request is a HyperText Transport Protocol (HTTP) request.

14. A computer program product comprising one or more computer-readable media having thereon one or more computer-executable instructions that, when executed by one or more processors of the server computing system, cause the computing system to perform the method of claim 8.

15. A computing system configured to perform the method recited in claim 8.

16. A computer program product comprising one or more computer-readable media having thereon computer-executable instructions that, when executed by one or more processors of a computing system, cause the computing system to perform the following in response to receiving a response to a network request for a web page, the response including a representation of the web page including at least one dynamic rendering control that may be used to render a portion of the web page:
an act of executing the dynamic rendering control;
while executing the dynamic rendering control, performing the following:
an act of determining that additional data is needed in order to fully render the portion of the web page;
an act of determining that the response includes an estimate of the additional data; and
an act of using the estimate of the additional data to render the portion of the web page using the dynamic rendering control.

17. A computer program product in accordance with claim 16, wherein the dynamic rendering control is part of a control tree.

18. A computer program product in accordance with claim 16, wherein the computer-executable instructions for performing the act of using the estimate of the additional data comprise computer-executable instructions for performing:
causing the dynamic rendering control to request the additional data from a data source control also provided in the representation of the web page; and
causing the data source control to provide the additional data to the dynamic rendering control.

19. A computer program product in accordance with claim 16, wherein the one or more computer-readable media are physical storage media.

20. A computer program product in accordance with claim 16, wherein the one or more computer-readable media are physical memory media.
